(19) United States
(12) Patent Application Publication
(10) Pub. No.: US 2014/0089186 A1
(43) Pub. Date: Mar. 27, 2014

(54) MOBILE PAYMENT SERVICE FOR SMALL FINANCIAL INSTITUTIONS

(71) Applicant: INTUIT INC., Mountain View, CA (US)

(72) Inventors: Eric C. W. Dunn, Palo Alto, CA (US); Alexander S. Ran, Palo Alto, CA (US)

(73) Assignee: INTUIT INC., Mountain View, CA (US)

(21) Appl. No.: 13/626,776

(22) Filed: Sep. 25, 2012

(51) Int. Cl. G06Q 20/10; G06Q 40/00

(52) U.S. Cl. 705/42; 705/35

(57) ABSTRACT

During operation of the system, a user of a portable electronic device provides a request to enroll in a financial service associated with a provider. For example, the financial service may facilitate financial transactions via a financial application that executes on the portable electronic device. Then, an electronic device determines that the user is an existing customer of at least one of a set of financial institutions that have a business relationship with the provider, where the provider is other than one of the financial institutions. Next, the electronic device enrolls the user in the financial service without requesting additional information from the user. By leveraging the business relationship between the user and one of the financial institutions in the set of financial institutions, the user can avoid having to perform a complicated enrollment process in order to start using the financial service.

### FIELD

The present disclosure relates to techniques offering a mobile-payment function to customers of small financial institutions based on a pre-paid financial instrument.

### SUMMARY

The disclosed embodiments relate to an electronic device that enrolls a user in a financial service. During operation, the electronic device receives a user request to enroll in the financial service associated with a provider that facilitates financial transactions via a financial application that executes on the electronic device. Then, the electronic device determines that the user is an existing customer of one of a set of financial institutions that have a business relationship with the provider, where the provider is other than one of the financial institutions. Next, the electronic device enrolls the user in the financial service without requesting additional information from the user.

Note that the financial transactions may include: making a deposit into a financial account (which may be associated with a pre-paid financial instrument), paying at the point of sale, and/or viewing a summary of the financial account.

Another embodiment provides a portable electronic device that facilitates transfer of funds for a financial service. During operation, the portable electronic device receives a user request to add funds to a virtual payment instrument associated with the portable electronic device, where the virtual payment instrument is implemented as a software object in a secure element on the portable electronic device. Then, the portable electronic device generates instructions for transferring funds between two financial accounts associated with financial institutions that have a business relationship with a provider of the financial service, where the two financial accounts may be with a financial institution that is associated with the provider, and the funds are transferred without requesting additional (e.g., detailed) payment information from the user.

Note that the funds may be transferred between the two financial accounts with or without a delay, and/or maybe available to the user with or without a delay.

Another embodiment provides a portable electronic device that provides funding to a virtual payment instrument. During operation, the portable electronic device receives a user request to add funds to the virtual payment instrument associated with the portable electronic device, where the virtual payment instrument is implemented as a software object in a secure element on the portable electronic device, and the virtual payment instrument is a virtual representation of a financial instrument that is other than a physical financial instrument. In response to the request, the portable electronic device provides the funds to the virtual payment instrument.

Note that a physical financial instrument corresponding to the virtual payment instrument may not exist. Moreover, the request may be based on proximity of the portable electronic device to another electronic device. Furthermore, note that multiple physical financial instruments may correspond to the virtual payment instrument.

Another embodiment provides a portable electronic device that facilitates a secure financial transaction. During operation, the portable electronic device receives a request to conduct the financial transaction via a financial application that combines banking on the portable electronic device with mobile payments. In response to the request, the portable electronic device transfers funds from a financial account of a user of the portable electronic device with a financial institution to a virtual payment instrument associated with the portable electronic device, where the virtual payment instrument is implemented as a software object in a secure element on the portable electronic device. Then, the portable electronic device conducts the financial transaction using the financial application.

Note that the transferring of the funds and the conducting of the financial transaction may occur without user action. Furthermore, if network connectivity between the portable electronic device and the financial institution is unavailable, the portable electronic device may receive an identifier from the user to authenticate the user. Additionally, transferring the funds may leverage historical information about the financial account stored in the virtual payment instrument.

In some embodiments, conducting the financial transaction within the limit of funds pre-paid to the virtual payment instrument occurs without user authentication or another user action.

Another embodiment provides one or more methods that include at least some of the operations performed by one or more of the embodiments of the portable electronic device.

Another embodiment provides one or more computer-program products for use with one or more of the embodiments of the portable electronic device. These one or more computer-program products include instructions for at least some of the operations performed by one or more of the embodiments of the portable electronic device.

### BRIEF DESCRIPTION OF THE FIGURES

FIG. 1 is a flow chart illustrating a method for enrolling a user in a financial service in accordance with an embodiment of the present disclosure.

FIG. 2 is a flow chart illustrating the method of FIG. 1 in accordance with an embodiment of the present disclosure.

FIG. 3 is a flow chart illustrating a method for funding a financial service in accordance with an embodiment of the present disclosure.

FIG. 4 is a flow chart illustrating the method of FIG. 3 in accordance with an embodiment of the present disclosure.

FIG. 5 is a flow chart illustrating a method for providing funding to a virtual payment instrument in accordance with an embodiment of the present disclosure.

FIG. 6 is a flow chart illustrating the method of FIG. 5 in accordance with an embodiment of the present disclosure.

FIG. 7 is a flow chart illustrating a method for providing a secure financial transaction in accordance with an embodiment of the present disclosure.

FIG. 8 is a flow chart illustrating the method of FIG. 7 in accordance with an embodiment of the present disclosure.

FIG. 9 is a block diagram illustrating a system that performs the methods of FIGS. 1-8 in accordance with an embodiment of the present disclosure.

FIG. 10 is a block diagram illustrating a portable electronic device that performs the methods of FIG. 1-8 in accordance with an embodiment of the present disclosure.

FIG. 11 is a block diagram illustrating a data structure for use with the portable electronic device of FIG. 10 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of an electronic device, a portable electronic device, a technique for implementing financial services on the portable electronic device, and a computer-program product (e.g., software) for use with the portable electronic device are described. During this financial technique, a user of the portable electronic device provides a request to enroll in a financial service (such as a mobile-payment service) associated with a provider. For example, the financial service may facilitate financial transactions via a financial application that executes on the portable electronic device. Then, the electronic device determines that the user is an existing customer of at least one of a set of financial institutions that have a business relationship with the provider, where the provider is other than one of the financial institutions. Next, the electronic device enrolls the user in the financial service without requesting additional information from the user.

By leveraging the business relationship between the user and one of the financial institutions in the set of financial institutions, the user may not have to perform a complicated enrollment process in order to start using the financial service. In particular, the user may not have to provide additional financial information. This ‘instant’ activation of the financial service may greatly simplify the enrollment process for the user, reducing its duration and eliminating multiple operations. Furthermore, via the set of financial institutions, the provider may be able to instantly fund the financial service on the portable electronic device (for example, by providing funds for mobile payments). Indeed, the portable electronic device may be used as a virtual payment instrument for the user (thereby obviating the need for a corresponding physical payment instrument, such as a debit or credit card). In addition, the financial application may also offer online banking (and other services), thereby offering the user convenience and enhanced security. In this way, the financial technique may improve the user's customer experience and increase their satisfaction, which may make it more likely that the user will use the portable electronic device to conduct financial transactions. Therefore, the financial technique may promote commercial activity.

In the discussion that follows, a user may include: an individual (for example, an existing customer, a new customer, a service provider, a vendor, a contractor, etc.), an organization, a business and/or a government agency. Furthermore, a ‘business’ should be understood to include: for-profit corporations, non-profit corporations, organizations, groups of individuals, sole proprietorships, government agencies, partnerships, etc.

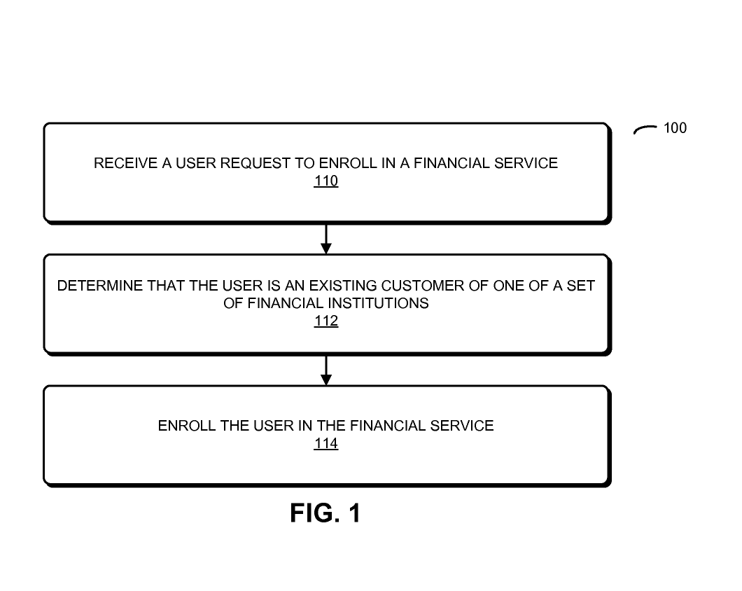

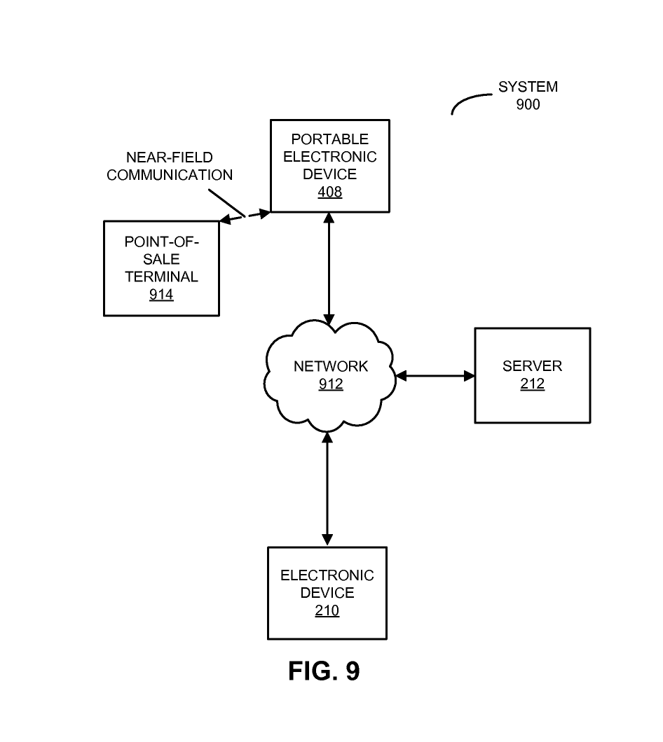

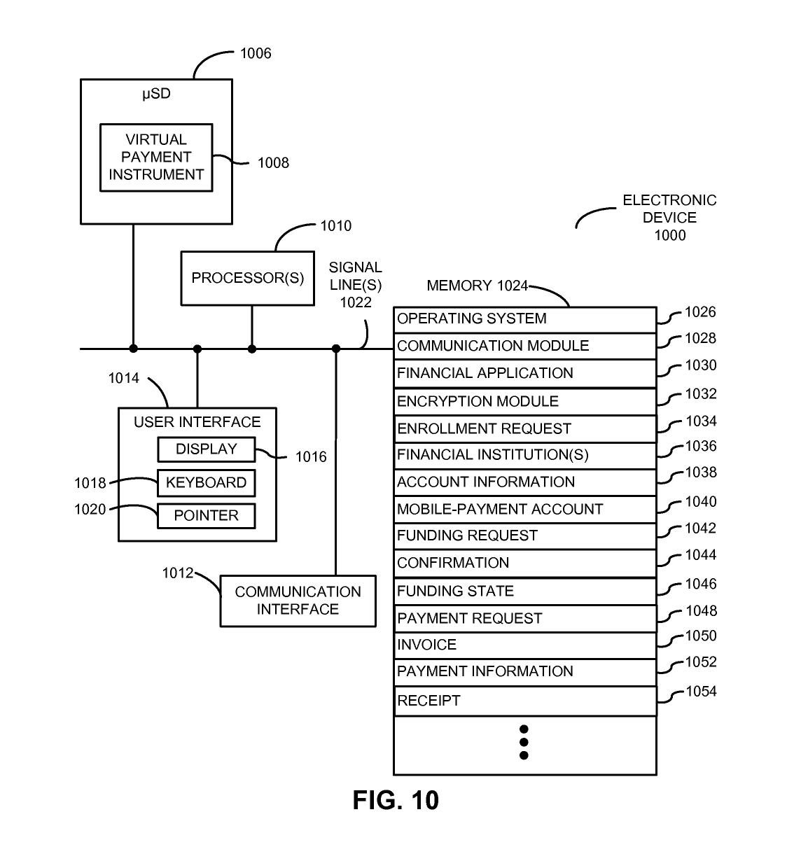

We now describe embodiments of the financial technique, which may be performed by an electronic device (such as electronic device 1000 in FIG. 10) in a system (such as system 900 in FIG. 9). Note that the electronic device may or may not be portable. FIG. 1 presents a flow chart illustrating a method 100 for enrolling a user in a financial service. During operation, the electronic device receives a user request (operation 110) to enroll in the financial service (such as a mobile-payment service) associated with a provider that facilitates financial transactions via a financial application (such as a mobile-payment application) that executes on a portable electronic device. For example, the financial transactions may include: making a deposit into a financial account, paying at a point of sale, and/or viewing a summary of the financial account.

Then, the electronic device determines that the user is an existing customer of one of a set of financial institutions (operation 112) that have a business relationship with the provider, where the provider is other than one of the financial institutions. For example, the set of financial institutions may include banks, such as small banks (which do not have the infrastructure needed to offer the financial service to their customers and instead use the service offered by the provider.) Next, the electronic device enrolls the user in the financial service (operation 114) without requesting additional information from the user by leveraging the existing business relationship between the user and the financial institution and the financial institution and the provider.

In some embodiments, the electronic device optionally activates a mobile payment financial service without requesting additional information from the user (not shown).

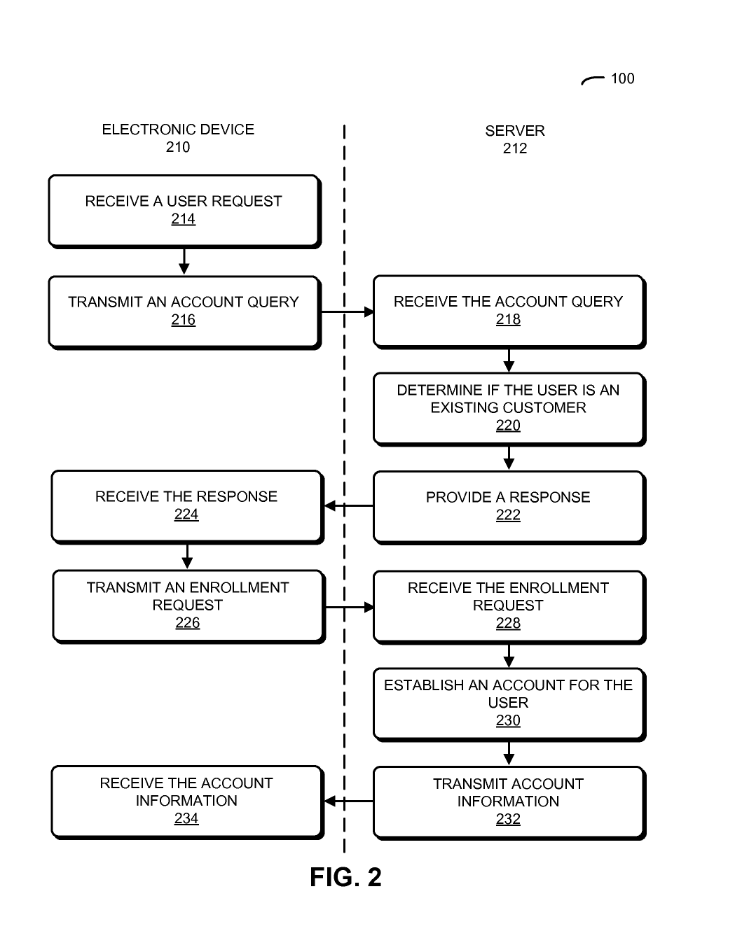

In an exemplary embodiment, method 100 is implemented using an electronic device (such as a computer or a server) and at least one server (which is associated with and is used by the provider), which communicate through a network, such as a cellular-telephone network and/or the Internet (e.g., using a client-server architecture). This is shown in FIG. 2, which presents a flow chart illustrating method 100. During this method, electronic device 210 receives the user request (operation 214) to enroll in the financial service associated with the provider that facilitates financial transactions via the financial application that executes on a portable electronic device (not shown).

In response to the user request, electronic device 210 determines if the user is an existing customer of one of the set of financial institutions that have the business relationship with the provider. For example, electronic device 210 may transmit an account query (operation 216) to server 212 (which is associated with the provider). After receiving the account query (operation 218), server 212 accesses a data structure to determine if the user is an existing customer (operation 220). Then, server 212 provides a response (operation 222) which indicates whether or not the user is an existing customer.

After receiving the response (operation 224), electronic device 210 enrolls the user in the financial service without requesting additional (detailed) information from the user. For example, electronic device 210 may transmit an enrollment request (operation 226) to server 212. After the enrollment request is received (operation 228), server 212 may establish an account for the user (operation 230) based on user financial information that is known to the provider (for example, the financial information, which may be stored in a data structure, may have been shared by one of the financial institutions in the set of financial institutions). Next, server 212 transmits account information (operation 232), which is subsequently received (operation 234) by electronic device 210.

By leveraging an existing relationship between at least one of the set of financial institutions and the user or the customer, this financial technique may facilitate instant enrollment or provisioning (i.e., instant activation) of mobile payments and/or other financial services via the financial application. Because the user's financial information is known to the provider, the provider does not have to obtain additional information (for example, by asking additional questions) before enrolling the user and activating the mobile-payment service (via the financial application) on electronic device 210.

Note that the provider may have previously provided the financial application to the set of financial institutions, which in turn provided it to their customers for use on portable electronic devices. Alternatively, the users or customers may have received the financial application from the provider. As described further below, once installed on the users' portable electronic devices, the financial application can be used to manage the users' relationships with the set of financial institutions.

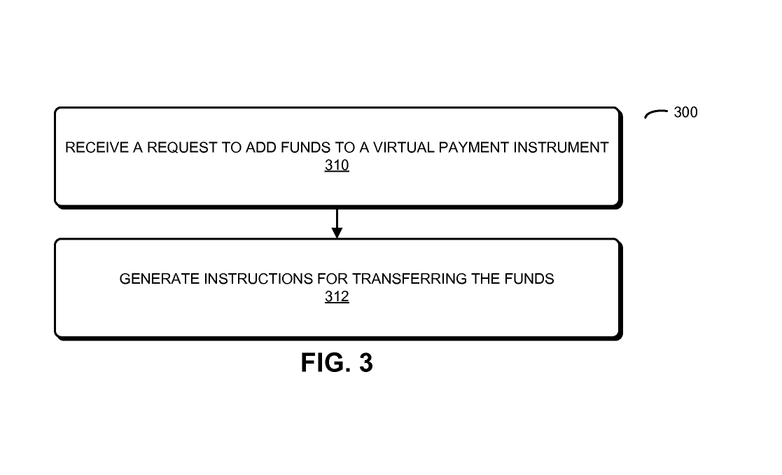

FIG. 3 presents a flow chart illustrating a method 300 for facilitating the transfer of funds for a financial service, which may be performed by a portable electronic device (such as electronic device 1000 in FIG. 10) in a system (such as system 900 in FIG. 9). During operation, the portable electronic device receives a user request to add funds to a virtual payment instrument (operation 310) associated with the portable electronic device, where the virtual payment instrument is implemented as a software object in a secure element on the portable electronic device. Then, the portable electronic device generates instructions for transferring the funds (operation 312) between two financial accounts associated with financial institutions that have a business relationship with a provider of the financial service, where the two financial accounts may be with a financial institution that is associated with the provider, and the funds are transferred without requesting additional (detailed) payment information from the user. Note that the funds may be transferred between the two financial accounts with or without a delay, and/or maybe available to the user with or without a delay.

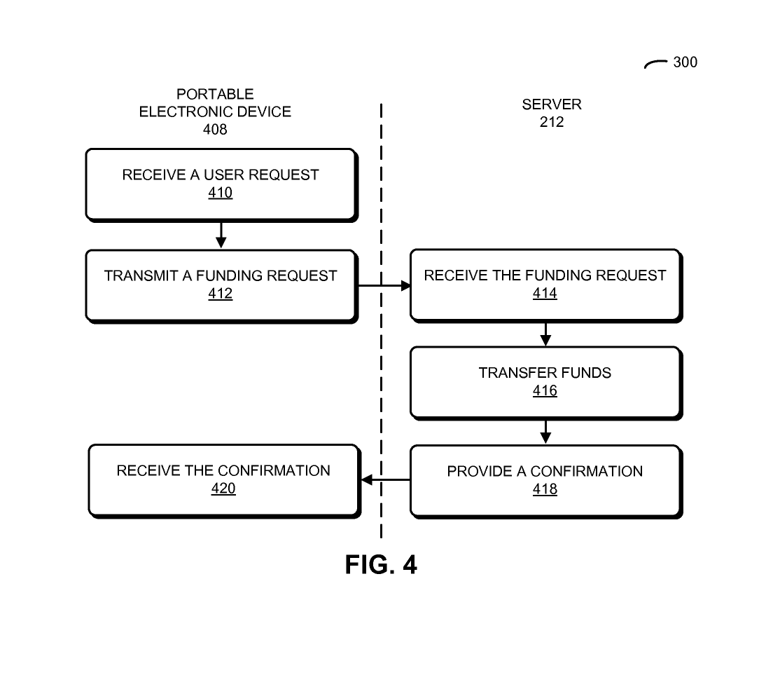

In an exemplary embodiment, method 300 is implemented using a portable electronic device (such as a cellular telephone or a computer) and at least one server (which is associated with and is used by the provider), which communicate through a network, such as a cellular-telephone network and/or the Internet (e.g., using a client-server architecture). This is shown in FIG. 4, which presents a flow chart illustrating method 300. During this method, portable electronic device 408 receives the user request (operation 410) to add funds to the virtual payment instrument associated with portable electronic device 408.

Then, portable electronic device 408 provides the funds by transferring funds between two financial accounts associated with financial institutions that have the business relationship with the provider of the financial service. For example, portable electronic device 408 may transmit a funding request (operation 412) to server 212. After receiving this request (operation 414), server 212 may transfer the funds (operation 416) between the two financial accounts. Then, server 212 may provide a confirmation (operation 418) of the fund transfer that is received (operation 420) by portable electronic device 408.

In some embodiments, portable electronic device 408 includes a virtual payment instrument that is implemented as a software object in a secure element (such as an encrypted chip) on portable electronic device 408. This virtual payment instrument (or virtual object) may function as a general purpose reloadable card that can be ‘instantly’ funded (i.e., there is real-time access to funds at little or no cost). This may be possible because the fund transfer needed may not be occurring between two banks, which is usually the case with an automated clearing house. Instead, two different transfers are made, each within a single financial institution. Thus, the money or funds may be ‘moved’ immediately between the user accounts and the financial accounts maintained by the provider (i.e., the fund transfer occurs inside one financial institution, as opposed to between financial institutions, so it is instantaneous). For example, the user's mobile payment account may be with the provider and, because of the business relationship between the set of financial institutions and the provider, information about the user's financial account (such as a bank account) with at least one of the set of financial institutions may also be available to the provider. Therefore, the provider may have access to an account balance and a financial transaction history associated with the user's financial account. This may allow the provider to temporarily float the funds to the user's mobile-payment account with little or no risk. Subsequently, the funds may be repaid to the provider by at least one of the set of financial institutions that provides financial services (including the financial account) to the user. Note that, because the provider has access to the user's financial information based on the provider's business relationships with the set of financial institutions, the funds may be transferred by the provider (i.e., the mobile-payment service may be provisioned) without requesting (detailed) payment information from the user.

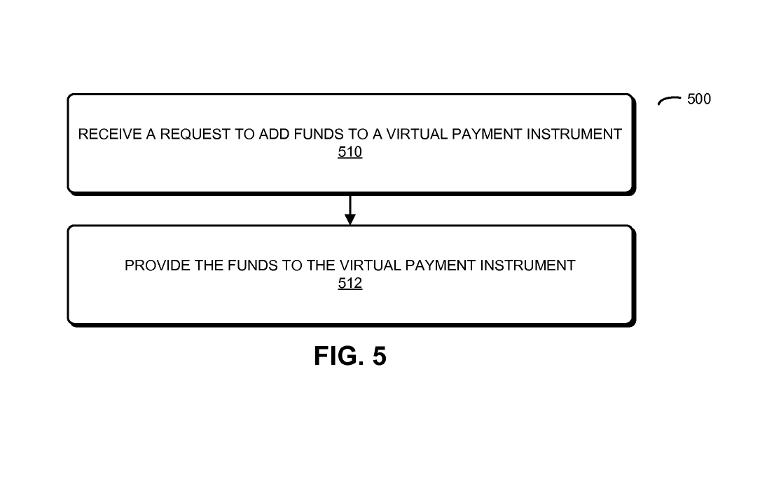

FIG. 5 presents a flow chart illustrating a method 500 for providing funding to a virtual payment instrument, which may be performed by a portable electronic device (such as electronic device 1000 in FIG. 10) in a system (such as system 900 in FIG. 9). During operation, the portable electronic device receives a user request to add funds to the virtual payment instrument (operation 510) associated with the portable electronic device, where the virtual payment instrument is implemented as a software object in a secure element on the portable electronic device, and the virtual payment instrument is a virtual representation of a financial instrument that is other than a physical financial instrument. In response to the request, the portable electronic device provides the funds to the virtual payment instrument (operation 512).

Note that a physical financial instrument corresponding to the virtual payment instrument may not exist. Moreover, note that multiple physical financial instruments may correspond to the virtual payment instrument. Furthermore, the request may be based on proximity of the portable electronic device to another electronic device. For example, by tapping the portable electronic device on a point-of-sale terminal or a bank machine, funds may be provided to or withdrawn from the virtual payment instrument.

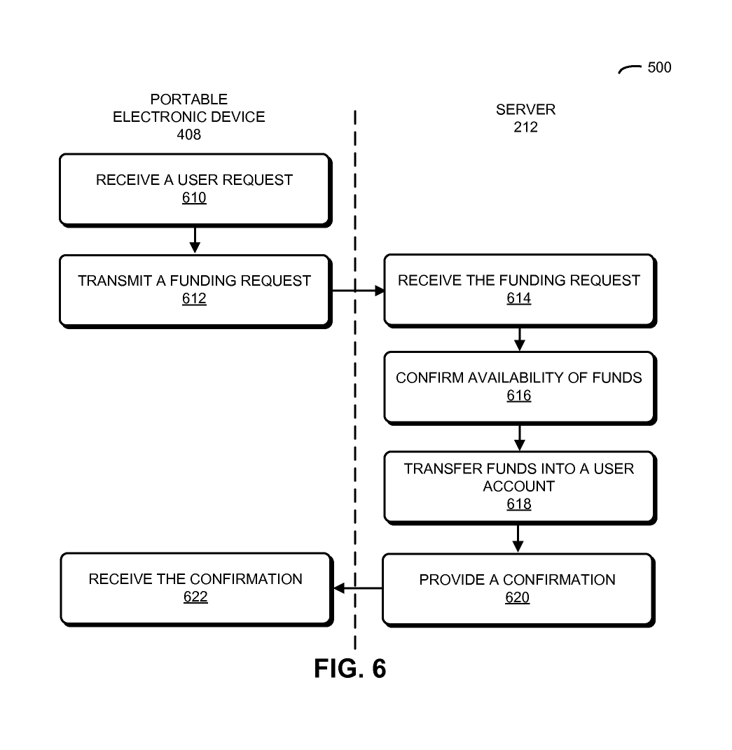

In an exemplary embodiment, method 500 is implemented using a portable electronic device (such as a cellular telephone or a computer) and at least one server (which is associated with and is used by the provider), which communicate through a network, such as a cellular-telephone network and/or the Internet (e.g., using a client-server architecture). This is shown in FIG. 6, which presents a flow chart illustrating method 500. During this method, portable electronic device 408 receives the user request (operation 610) to add funds to the virtual payment instrument associated with portable electronic device 408.

In response to the request, portable electronic device 408 provides the funds to the virtual payment instrument. For example, portable electronic device 408 may transmit a funding request (operation 612) to server 212. After receiving the funding request (operation 614), server 212 may confirm the availability of funds (operation 616) in one or more financial accounts associated with the user. (Therefore, via this link to the user's financial account with one of the set of financial institutions, the virtual payment instrument may effectively function as a prepaid, general-purpose reloadable virtual payment instrument or card.) Then, server 212 may transfer funds into a user account (operation 618) associated with the mobile-payment service. Moreover, server 212 may provide a confirmation (operation 620) of the funding, which is subsequently received (operation 622) by portable electronic device 408, thereby enabling the user to conduct financial transactions with the mobile-payment service.

As noted previously, mobile payments may be implemented using the virtual payment instrument, which is implemented as a software object in a secure element on the portable electronic device. This virtual payment instrument may function as a virtual money clip (and thus funds associated with the virtual payment instrument may be used as ‘mobile money’). Moreover, the virtual payment instrument may not have a physical counterpart, i.e., it may not be associated with a real debit or credit card (and, more generally, a financial instrument). Indeed, there may not be a debit or credit card. Thus, in the financial technique the mobile payments may be based on the portable electronic device, as opposed to a debit or credit card.

In this way, the mobile payments may disconnect or decouple an actual or physical payment instrument from the consumer-facing representation of the payment instrument (which, in this case, is the financial application executing on the portable electronic device). This approach is advantageous, because it enables the use of multiple and different actual or physical payment instruments as the vehicles for financial transactions conducted using the portable electronic device. In this way, the user is freed from complexity of managing multiple payment instruments. This financial technique also enables the provider of the financial service to offer the financial service on behalf of multiple small financial institutions. Additionally, this financial technique may allow the provider to offer a white-label payment service to the customers of multiple small financial institutions without the complexity associated with working with multiple different issuers of payment instruments.

In method 500, the user may ‘top up’ or add funds to the virtual payment instrument via the financial application. For example, when the user activates a physical icon on a keypad or a virtual icon on a touchscreen, the financial application may inquire if the user would you like to make a mobile payment. If yes, a virtual money-clip icon may be displayed. In addition, the user can put ‘money’ into the virtual money clip, for example, directly from the user's debit account. Thus, the user can top up the virtual money clip, just like using an automated teller machine. If the user taps a point-of-sale terminal that is configured to conduct contactless payments (for example, using near-field communication, wireless communication and/or another type of communication), and funds first need to be added to the user's mobile-payment account, method 500 may be performed before the mobile payment (and, more generally, a financial transaction) is conducted.

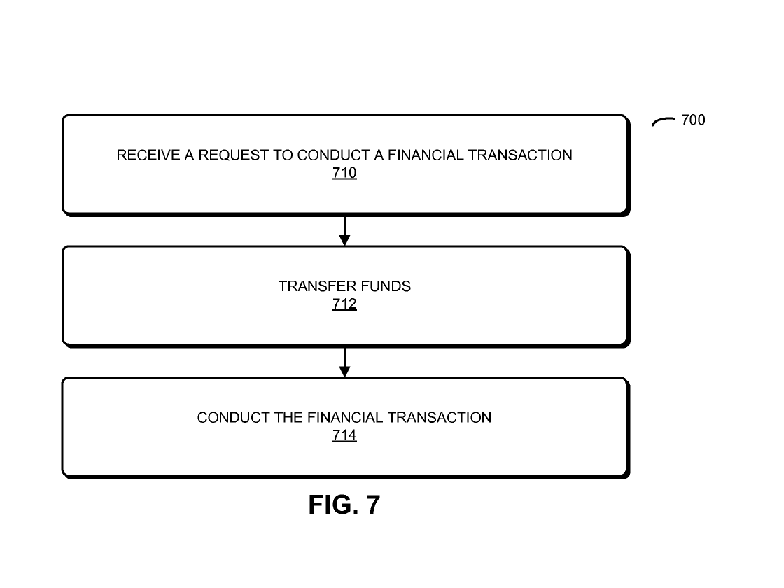

FIG. 7 presents a flow chart illustrating a method 700 for providing a secure financial transaction, which may be performed by a portable electronic device (such as electronic device 1000 in FIG. 10) in a system (such as system 900 in FIG. 9). During operation, the portable electronic device receives a request to conduct the financial transaction (operation 710) via a financial application that combines banking on the portable electronic device with mobile payments. In response to the request, the portable electronic device transfers funds (operation 712) from a financial account of a user of the portable electronic device with a financial institution to a virtual payment instrument associated with the portable electronic device, where the virtual payment instrument is implemented as a software object in a secure element on the portable electronic device. Then, the portable electronic device conducts the financial transaction (operation 714) using the financial application.

Note that the transferring of the funds and the conducting of the financial transaction may occur without user action. Furthermore, if network connectivity between the portable electronic device and the financial institution is unavailable, the portable electronic device may receive an identifier from the user to authenticate the user (for example, based on stored authentication information on the portable electronic device or the secure element). Additionally, transferring the funds may leverage historical information about the financial account stored in the virtual payment instrument. In this way, even if network connectivity is lost, the portable electronic device may be able to confirm that funds are available for a financial transaction.

In some embodiments, conducting the financial transaction within the limit of funds pre-paid to the virtual payment instrument occurs without user authentication or other user action.

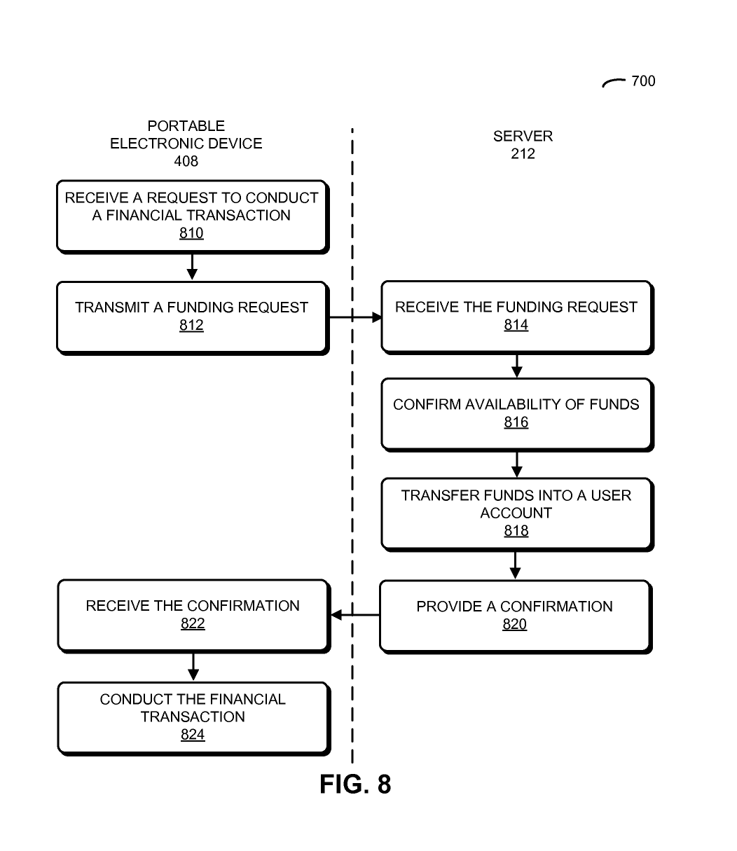

In an exemplary embodiment, method 700 is implemented using a portable electronic device (such as a cellular telephone or a computer) and at least one server (which is associated with and is used by the provider), which communicate through a network, such as a cellular-telephone network and/or the Internet (e.g., using a client-server architecture). This is shown in FIG. 8, which presents a flow chart illustrating method 700. During this method, portable electronic device 408 receives a request (operation 810) to conduct the financial transaction via the financial application that combines banking on the portable electronic device with mobile payments.

In response to the request, portable electronic device 408 transfers funds from a financial account of a user of the portable electronic device with a financial institution to the virtual payment instrument associated with the portable electronic device. For example, portable electronic device 408 may transmit a funding request (operation 812) to server 212. After receiving the funding request (operation 814), server 212 may confirm the availability of funds (operation 816) in one or more financial accounts associated with the user. Then, server 212 may transfer funds into a user account (operation 818) associated with the mobile-payment service. Moreover, server 212 may provide a confirmation (operation 820) of the funding, which is subsequently received (operation 822) by portable electronic device 408.

Next, portable electronic device 408 conducts the financial transaction using the financial application (operation 824). For example, using near-field communication, the financial application may communicate with a point-of-sale terminal to receive an invoice and to provide corresponding payment information.

Thus, in some embodiments the financial application may combine online banking with mobile payments on portable electronic device 408 (which is collectively sometimes referred to as a ‘mobile-banking application’). This approach may provide convenience to the user (for example, the user can review their financial account balance before making a purchase or conducting a financial transaction) and enhance security without requiring that the user provide additional verification information. Furthermore, the user can transfer funds to an account associated with the mobile-payment service and can make payments using a single financial application.

This integrated solution may also allow the user to use the mobile-payment service even when there is no network connectivity (and, more generally, no communication) between portable electronic device 408 and server 212. In this case, the user can log in to the financial application by providing a username and password, a PIN or an identifier (and, more generally, authentication information). Then, leveraging cached financial-account information in the secure element on portable electronic device 408 (which may include a latest update of the financial-account balance(s) and recent financial transactions), the financial application may have access to the information needed to transfer funds (if needed) to a financial account associated with the mobile-payment service and to allow the user to conduct one or more financial transactions (such as making a mobile payment). Thus, while embodiments of the financial technique were illustrated using a client-server architecture in FIGS. 2, 4, 6 and 8, in some embodiments the financial technique may be performed by the financial application without real-time interaction with server 212.

In some embodiments, the payment capability does not require any authentication and thus can be performed with a single tap of the portable electronic device on the point of sale without any other user action (such as entering a PIN or a password). However, transferring funds to mobile payment account may require authentication. In this way, the risk of loosing the funds if the portable electronic device is lost may be limited to the small balance maintained in the mobile payment account only. This approach trades off the convenience of frictionless payment experience and financial risk.

In an exemplary embodiment, the financial application enables a mobile-payment service for customers of small banks (and, more generally, small financial institutions). This mobile-payment service may not require consumers to create new financial relationships, or to provide significant amounts of financial information to enroll, fund or use the mobile-payment service. In particular, a customer may be enrolled in the mobile-payment service by their bank, for example, during a visit to a branch, during an online or mobile-banking session, or in another context where a previously established identity of a customer is authenticated. Because the enrollment in the mobile-payment service occurs via the existing relationships with the bank, no new information is required, thereby eliminating the need for any additional interaction with the customer.

Moreover, a virtual general purpose reloadable (GPR) payment card (i.e., the virtual payment instrument) may be provisioned to the customer's portable electronic device (such as their cellular telephone), either via over-the-air (OTA) provisioning or on a secure hardware add-on device, such as a micro SD (μSD) card. For example, OTA provisioning may be performed to the embedded secure element of the portable electronic device identified by the authenticated customer. Alternatively, a μSD may be mailed to the known address of the customer along with installation instructions.

After the virtual payment instrument or card has been provisioned to the customer's portable electronic device, when the customer initiates an authenticated mobile-banking session, the newly provisioned virtual payment instrument may be activated without any additional user interaction. Then, the mobile-banking application (i.e., the financial application) can offer the customer new capabilities and services that are enabled by the virtual payment instrument. For example, funds can be moved in real-time between the customer's designated (or default) bank account and the account of the virtual payment instrument (and, thus, the account associated with the mobile-payment service) without requiring a setup procedure. Thus, by leveraging an existing banking relationship in combination with a virtual GPR payment card, instant enrollment, instant funding and efficient provisioning can all be provided to the customer. Furthermore, use of the virtual GPR payment card may be transparent to the customer.

In an exemplary embodiment, the provider of the mobile-payment service may request that a prepaid processor create prepaid virtual-payment-card accounts for customers of a bank. In response, the prepaid processor may provide vendor card files to a card vendor/personalization bureau.

If the virtual payment instruments are provisioned on μSD-based add-on devices, the process may involve the provider requesting that an add-on device manufacturer provide a batch of μSDs along with keys for secure elements on the μSDs to the card vendor/personalization bureau. Then, the card vendor/personalization bureau may provision the μSDs with the financial application, and may personalize each μSD with customer-account information.

When a customer of the bank signs up for the mobile-payment service, they may receive a μSD with a prepaid virtual payment instrument and they may install the μSD in their portable electronic device. Note that the provider may associate the prepaid virtual-payment-card account with the identity of the customer. Then, when the customer logs in to the financial application using their existing credentials, the financial application obtains from the secure element information that allows the provider to identify the prepaid virtual-payment-card account and to associate it (or to verify the association) with the identity of the customer.

Alternatively, the virtual payment instruments may be provisioned OTA to secure elements that are already embedded in or added-on to portable electronic devices (for example, by a manufacturer of the portable electronic devices). In these embodiments, the vendor card files and the secure-element keys may be provided to a trusted service manager. When a user (such as a customer of a bank) logs in to the financial application and requests to activate the mobile-payment service, the financial application obtains identification information from the secure element and provides it to the trusted service manager. Using secure-element-specific keys, the trusted service manager establishes a secure channel to the secure element and provisions a virtual payment instrument to the secure element. In this way, the prepaid virtual-payment-card account may be associated with the authenticated user.

Using either or both of these approaches, the mobile-payment functionality may be activated with minimum user interaction. Furthermore, the financial application may aggregate information about all of the user's financial accounts, and may provide payment-related functionality and mobile-banking functionality (including real-time funding of the mobile-payment or the virtual-payment-card account).

In some embodiments of methods 100 (FIGS. 1 and 2), 300 (FIGS. 3 and 4), 500 (FIGS. 5 and 6) and/or 700 (FIGS. 7 and 8), there are additional or fewer operations. Moreover, the order of the operations may be changed, and/or two or more operations may be combined into a single operation.

In the preceding methods, there are several instances of an enrollment operation of a user in the service. A variety of techniques may be used during this enrollment operation, including: using a mobile application connected the service(s) of the financial institution; using Web interface to the service(s) of the financial institution; via a phone through customer service at the financial institution; in person in a branch of the financial institution; and/or using another technique in which the user can be identified and authenticated as the principal (owner) of the relationship (the financial account) with the financial institution. Thus, using one or more of these techniques, the user may be able to link the information associated with their relationship with the financial institution and their identity with the payment-service provider.

We now describe embodiments of the system and the portable electronic device, and their use. FIG. 9 presents a block diagram illustrating a system 900 that performs the methods of FIGS. 1-8. In this system, a user of portable electronic device 408 may use a software application or product, such as a financial software application (which is sometimes referred to as the ‘financial application’) that is resident on and that executes on portable electronic device 408. (Alternatively, the user may interact with a web page that is provided by server 212 via network 912, and which is rendered by a web browser on portable electronic device 408. For example, at least a portion of the financial software application may be an application tool that is embedded in the web page, and which executes in a virtual environment of the web browser. Thus, the application tool may be provided to the consumer via a client-server architecture.) This financial software application may be a standalone application or a portion of another application that is resident on and which executes on portable electronic device 408 (such as a software application that is provided by server 212 or that is installed and which executes on portable electronic device 408).

As discussed previously, the user may provide the user request to enroll in the financial service associated with the provider that facilitates financial transactions via a financial software application that executes on electronic device 210 (such as a computer or a server). For example, the user may click on a physical button or may activate a virtual icon on a touchscreen. In response to the user request, electronic device 210 may transmit the account query to server 212 via network 912. Then, server 212 may provide a response to electronic device 210 via network 912 that indicates whether the user is an existing customer of one of the set of financial institutions that have the business relationship with the provider.

If the response indicates that the user is an existing customer, electronic device 210 may transmit an enrollment request to server 212 via network 912. In response, server 212 may establish an account for the user based on user financial information that is known to the provider. Then, server 212 transmits account information to electronic device 210 via network 912. In this way, the financial software application can enroll the user in the financial service without requesting additional information from the user.

After the user is enrolled, the user may request that funds be added to the virtual payment instrument associated with portable electronic device 408. For example, the user may tap on an ‘add funds’ icon that is displayed on a touchscreen. In response, portable electronic device 408 may transmit a funding request to server 212 via network 912. After receiving this request, server 212 may generate instructions for transferring the funds or may transfer the funds between the two financial accounts associated with financial institutions that have the business relationship with the provider of the financial service. Alternatively, server 212 may confirm the availability of funds in one or more financial accounts associated with the user, and may transfer funds into a user account associated with the mobile-payment service. Then, server 212 may provide a confirmation of the fund transfer to portable electronic device 408 via network 912. In this way, the financial software application may provide real-time funding of the virtual payment instrument without requesting payment information from the user.

Once funds have been transferred to the virtual payment instrument, the user may use it to conduct mobile payments (and, more generally, financial transactions). In some embodiments, the financial software application also includes mobile-banking functionality, which may allow the user to check account balances, transfer funds, and access other services seamlessly within one integrated application. For example, in response to a request from the user to conduct a financial transaction with point-of-sale terminal 914 (for example, when the user activates a payment icon on a touchscreen), portable electronic device 408 may transmit a funding request to server 212 via network 912. In response, server 212 may confirm the availability of funds in one or more financial accounts associated with the user, and may transfer funds into a user account associated with the mobile-payment service. Then, server 212 may provide confirmation of the funding to portable electronic device 408 via network 912. Next, portable electronic device 408 may conduct the financial transaction with point-of-sale terminal 914, for example, using near-field communication to exchange an invoice, payment information, and a receipt.

Note that information in system 900 may be stored at one or more locations in system 900 (i.e., locally or remotely). Moreover, because this data may be sensitive in nature, it may be encrypted. For example, stored data and/or data communicated via network 912 may be encrypted.

FIG. 10 presents a block diagram illustrating an electronic device 1000 (which may or may not be portable) that performs the methods of FIG. 1-8. Electronic device 1000 includes one or more processing units or processors 1010, a communication interface 1012, a user interface 1014, and one or more signal lines 1022 coupling these components together. Note that the one or more processors 1010 may support parallel processing and/or multi-threaded operation, the communication interface 1012 may have a persistent communication connection, and the one or more signal lines 1022 may constitute a communication bus. Moreover, the user interface 1014 may include: a display 1016, a keyboard 1018, and/or a pointer 1020, such as a mouse.

Memory 1024 in electronic device 1000 may include volatile memory and/or non-volatile memory. More specifically, memory 1024 may include: ROM, RAM, EPROM, EEPROM, flash memory, one or more smart cards, one or more magnetic disc storage devices, and/or one or more optical storage devices. Memory 1024 may store an operating system 1026 that includes procedures (or a set of instructions) for handling various basic system services for performing hardware-dependent tasks. Memory 1024 may also store procedures (or a set of instructions) in a communication module 1028. These communication procedures may be used for communicating with one or more computers and/or servers, including computers and/or servers that are remotely located with respect to electronic device 1000.

Memory 1024 may also include multiple program modules (or sets of instructions), including: financial application 1030 (or a set of instructions), and/or encryption module 1032 (or a set of instructions). Note that one or more of these program modules (or sets of instructions) may constitute a computer-program mechanism.

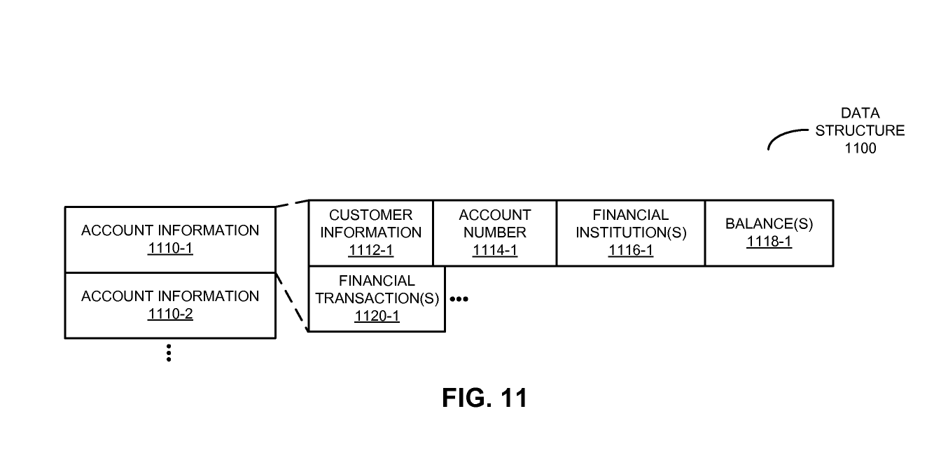

In embodiments where electronic device 1000 is not a portable electronic device, during operation financial application 1030 may receive an enrollment request 1034 (for example, via user interface 1014) to enroll in the financial service. In response, financial application 1030 may determine whether the user is an existing customer of one of the set of financial institutions 1036. For example, as further described below with reference to FIG. 11, financial application 1030 may access account information 1038 associated with existing customers of financial institutions 1036. If the user is an existing customer, financial application 1030 may establish a mobile-payment account 1040 for the user without requesting additional information from the user.

Alternatively, if electronic device is a portable electronic device, after the user is enrolled financial application 1030 may receive a funding request 1042 (for example, via user interface 1014) that funds be added to a virtual payment instrument 1008 in μSD 1006. In response, financial application 1030 may generate instructions for transferring funds or may transfer the funds between the two financial accounts associated with financial institutions that have the business relationship with the provider of the financial service. For example, financial application 1030 may communicate with server 212 (FIGS. 2, 4, 6, 8 and 9) using communication module 1028 and communication interface 1012. Alternatively, financial application 1030 may confirm the availability of funds in one or more financial accounts associated with the user, and may transfer funds into a user account associated with the mobile-payment service. Once the funds are transferred (for example, when financial application 1030 receives a confirmation 1044 from server 212 (FIGS. 2, 4, 6, 8 and 9) using communication module 1028 and communication interface 1012), financial application 1030 may update a funding state 1046 associated with the mobile-payment service. Note that the current funding state may be displayed graphically (for example, using an image of a money clip) on display 1016.

Then, financial application 1030 may be used to conduct mobile payments. For example, financial application 1030 may receive payment request 1048 (for example, via user interface 1014). In response, using communication module 1028 and communication interface 1012, financial application 1030 may: receive an invoice 1050, provide payment information 1052 and receive a receipt 1054. When payment is made, funding state 1046 may be appropriately modified.

If funding state 1046 is insufficient during a financial transaction, financial application 1030 may confirm the availability of funds in one or more financial accounts associated with the user (for example, using account information 1038), and may transfer funds into a user account associated with the mobile-payment service. In embodiments where financial application 1030 includes mobile-banking functionality, these operations may be performed within financial application 1030.

Account information 1038 used by financial application 1030 may be included in a data structure. This is shown in FIG. 11, which presents a block diagram illustrating a data structure 1100 for use with electronic device 1000 (FIG. 10). In particular, account information, such as account information 1110-1, may include: customer information 1112-1 (such as a customer name and contact information), account number 1114-1, financial institution 1116-1, balance(s) 1118-1, and/or financial transactions 1120-1.

Referring back to FIG. 10, because information in electronic device 1000 may be sensitive in nature, in some embodiments at least some of the data stored in memory 1024 and/or at least some of the data communicated using communication module 1028 is encrypted using encryption module 1032.

Instructions in the various modules in memory 1024 may be implemented in: a high-level procedural language, an object-oriented programming language, and/or in an assembly or machine language. Note that the programming language may be compiled or interpreted, e.g., configurable or configured, to be executed by the one or more processors 1010.

Although electronic device 1000 is illustrated as having a number of discrete items, FIG. 10 is intended to be a functional description of the various features that may be present in electronic device 1000 rather than a structural schematic of the embodiments described herein. In some embodiments, some or all of the functionality of electronic device 1000 may be implemented in one or more application-specific integrated circuits (ASICs) and/or one or more digital signal processors (DSPs).

Electronic device 1000 may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, electronic device 1000 may be capable of communication via a network, such as: the Internet, World Wide Web (WWW), an intranet, a cellular-telephone network, LAN, WAN, MAN, or a combination of networks, or other technology enabling communication between computing systems.

In some embodiments one or more of the modules in memory 1024 may be associated with and/or included in a financial application 1030. This financial application may include planning software capable of processing financial information. Moreover, financial application 1030 may include payroll or accounting software capable of processing payroll information.

Electronic device 1000 may include fewer components or additional components. Moreover, two or more components may be combined into a single component, and/or a position of one or more components may be changed. In some embodiments, the functionality of electronic device 1000 may be implemented more in hardware and less in software, or less in hardware and more in software, as is known in the art.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1-14. (canceled)

15. A portable-electronic-device-implemented method for providing a secure financial transaction, the method comprising:
using the portable electronic device, receiving a request to conduct the financial transaction via a financial application that combines banking on the portable electronic device with mobile payments;
in response to the request, transferring funds from a financial account of a user of the portable electronic device with a financial institution to a virtual payment instrument associated with the portable electronic device, wherein the virtual payment instrument is implemented as a software object in a secure element on the portable electronic device; and
conducting the financial transaction using the financial application.

16. The method of claim 15, wherein the transferring of the funds and the conducting of the financial transaction occur without user action.

17. The method of claim 15, wherein, if network connectivity between the portable electronic device and the financial institution is unavailable, the method further comprises receiving an identifier from the user to authenticate the user; and
wherein transferring the funds leverages historical information about the financial account stored in the virtual payment instrument.

18. The method of claim 15, wherein conducting the financial transaction within the limit of funds pre-paid to the virtual payment instrument occurs without user authentication.

19. A computer-program product for use in conjunction with a portable electronic device, the computer-program product comprising a non-transitory computer-readable storage medium and a computer-program mechanism embedded therein, to provide a secure financial transaction, the computer-program mechanism including:
instructions for receiving a request to conduct the financial transaction via a financial application that combines banking on the portable electronic device with mobile payments;
instructions for transferring funds from a financial account of a user of the portable electronic device with a financial institution to a virtual payment instrument associated with the portable electronic device in response to the request, wherein the virtual payment instrument is implemented as a software object in a secure element on the portable electronic device; and
instructions for conducting the financial transaction using the financial application.

20. The computer-program product of claim 19, wherein the transferring of the funds and the conducting of the financial transaction occur without user action.

21. The computer-program product of claim 19, wherein, if network connectivity between the portable electronic device and the financial institution is unavailable, the computer-program mechanism further includes instructions for receiving an identifier from the user to authenticate the user; and
wherein transferring the funds leverages historical information about the financial account stored in the virtual payment instrument.

22. A portable electronic device, comprising:
a processor;
memory; and
a program module, wherein the program module is stored in the memory and configurable to be executed by the processor to provide a secure financial transaction, the program module including:
instructions for receiving a request to conduct the financial transaction via a financial application that combines banking on the portable electronic device with mobile payments;
instructions for transferring funds from a financial account of a user of the portable electronic device with a financial institution to a virtual payment instrument associated with the portable electronic device in response to the request, wherein the virtual payment instrument is implemented as a software object in a secure element on the portable electronic device; and
instructions for conducting the financial transaction using the financial application.

23. The computer-program product of claim 19, wherein conducting the financial transaction within the limit of funds pre-paid to the virtual payment instrument occurs without user authentication.

24. The portable electronic device of claim 22, wherein the transferring of the funds and the conducting of the financial transaction occur without user action.

25. The portable electronic device of claim 22, wherein, if network connectivity between the portable electronic device and the financial institution is unavailable, the method further comprises receiving an identifier from the user to authenticate the user; and
wherein transferring the funds leverages historical information about the financial account stored in the virtual payment instrument.

26. The portable electronic device of claim 22, wherein conducting the financial transaction within the limit of funds pre-paid to the virtual payment instrument occurs without user authentication.
